(19) United States
(12) Patent Application Publication
(10) Pub. No.: US 2016/0124604 A1
(43) Pub. Date: May 5, 2016

(54) METHOD AND SYSTEM FOR SELECTING CONTINUOUSLY CONNECTED DISPLAY ELEMENTS FROM A USER INTERFACE DISPLAY USING A SINGLE CONTINUOUS SWEEPING MOTION

(71) Applicant: Intuit Inc., Mountain View, CA (US)

(72) Inventors: Phillip J. Ohme, San Diego, CA (US); Safia Ata Ali, San Francisco, CA (US); Heather Daggett, San Diego, CA (US)

(73) Assignee: Intuit Inc., Mountain View, CA (US)

(21) Appl. No.: 14/530,065

(22) Filed: Oct. 31, 2014

(51) Int. Cl. G06F 3/0481; G06F 3/0484; G06F 3/0488; G06F 3/0482

(52) U.S. Cl. CPC G06F 3/04812; G06F 3/0482; G06F 3/04842; G06F 3/04886; G06F 3/04845; G06F 2203/04803

(57) ABSTRACT

Display elements are displayed in a corresponding display region of a multi-display element interface display with continuously connected data display elements so that each display element is shown as connected to at least one other display element in a continuous manner. A user is provided the capability to make contact with two or more continuously connected data display regions of the display regions in the multi-display element interface display with continuously connected data display elements through a single continuous contact with multi-display element interface display on the display screen of the computing system. For each display region contacted by the user's single continuous contact with the display screen, the display element corresponding to the contacted display region is transformed into a selected display element.

### BACKGROUND

Computing systems, and in particular mobile computing systems, have become an integral part of many people's lives and activities. Consequently, on any given day, a user of a computing system, and particularly a user of a mobile computing system, may be presented with one or more user interface screens that include multiple display elements, also referred to herein as multi-display element interface displays. As used herein, the term “multi-display element interface display” includes, but is not limited to, user interface display screens that have multiple display elements that are displayed to the user in a graphical, or otherwise visual, display; typically in the form of a graphical display, list, or table. Typically, each of the multiple display elements in turn represents one or more data elements that can be selected by selecting the associated display element. Common examples of multi-display element interface displays include interface screens that display a list of display elements, such as emails; calendars presented as columns and rows of display elements representing dates; directories of display elements representing contacts, or other discrete display elements representing information and/or data; and/or other types of data elements represented by display elements in a multi-display element interface display.

Often it is the case that a user finds it necessary to select a subset of two or more display elements, and the data elements represented by the display elements, from a larger set of display elements in the multi-display element interface display. For instance, a user may desire to select only a subset of particular dates displayed in a calendar-based multi-display element interface. As another example, a user may desire to select only a subset of emails displayed in a multi-display element interface display. As another example, a user may desire to select only a sub-set of contacts, or items, represented by display elements. However, currently it is typically the case that a user desiring to select only a subset of display elements a multi-display element interface display must either select each display element individually, often through a series of repetitive individual actions such as tapping a checkbox associated with each individual display element desired, or the user is provided a “select all” option which, when activated, selects every display element displayed in the multi-display element interface display. Then the user must deselect undesired elements individually through a series of repetitive individual actions such as tapping a checkbox associated with each individual display element that is not desired.

Consequently, using currently available multi-display element interface displays, a user who needs to select only a subset of display elements in a multi-display element interface display is forced to perform multiple individual and repetitive inter-actions with the multi-display element interface display. This is highly inefficient, time-consuming, and often results in an unsatisfactory user experience, even in a traditional desktop environment. However, in a mobile environment, the necessity of individually selecting each desired display element in a multi-display element interface display, often displayed on a very small computing system display screen, is not only inefficient and time-consuming but is also particularly susceptible to error and user frustration. Consequently, the fields of data entry/selection and user experience are currently adversely affected by this long standing problem.

What is needed is a solution to the long standing problem of providing an efficient method and system to select a desired subset of display elements through a multi-display element interface display that will significantly improve the technical fields of data entry/selection and user experience, and thereby provide more efficient and effective data processing, communications, and computing systems.

### SUMMARY

Embodiments of the present disclosure address some of the shortcomings associated with prior art multi-display element interface displays by providing visually connected display elements, representing data elements, in a multi-display element interface display with continuously connected data display elements that can be selected, in any order or subset grouping of continuously connected display elements, through a single continuous contact with the display screen displaying the multi-display element interface display with continuously connected data display elements.

In one embodiment, a method and system for providing a multi-display element interface display with continuously connected data display elements selectable through a single continuous motion includes defining two or more data elements to be represented by display elements in a multi-display element interface display with continuously connected data display elements. In one embodiment, the display elements representing the data elements are then generated and each data element is associated with a corresponding display element.

In one embodiment, two or more display regions of the multi-display element interface display with continuously connected data display elements are designated. In one embodiment, each of the display regions of the multi-display element interface display with continuously connected data display elements are positioned in the multi-display element interface display with continuously connected data display elements such that at least a portion of each display region is represented as connected to at least one other display region. In one embodiment, each display element is then displayed in a corresponding display region of the multi-display element interface display with continuously connected data display elements such that each display element is displayed in that display element's corresponding display region of the multi-display element interface display with continuously connected data display elements.

In one embodiment, the multi-display element interface display with continuously connected data display elements is then generated and displayed on a display screen of a computing system and a user is provided access to the multi-display element interface display with continuously connected data display elements on the display screen of the computing system. In one embodiment, the user is then provided the capability to make contact with two or more continuously connected display regions of the display regions in the multi-display element interface display with continuously connected data display elements through a single continuous contact motion with the multi-display element interface display with continuously connected data display elements on the display screen of the computing system.

In one embodiment, for each connected display region contacted by the user's single continuous contact motion with the display screen, the display element corresponding to the contacted display region is transformed into a selected display element. In one embodiment, the data elements associated with each of the selected display elements are then transformed into selected data elements. In one embodiment, the selected data elements are then accumulated in a selected data element set and the selected data element set is stored as selected data.

In one embodiment, using the method and system for providing a multi-display element interface display with continuously connected data display elements selectable through a single continuous motion discussed herein, a solution to the long standing problem of providing an efficient method and system to select a desired subset of display elements through a multi-display element interface display is provided that significantly improves the technical fields of data entry/selection and user experience. Specifically, a user's experience is improved and simplified using embodiments of the present disclosure so that the user experience is less burdensome and the user can dedicate more of his or her time to other activities. Therefore, implementations of embodiments of the present disclosure represent a significant improvement to the field of user experience and, in particular, efficient use of human and non-human resources.

In addition, by eliminating the necessity of individually selecting each desired display element in a multi-display element interface display, there are fewer data entry actions to process, and fewer errors in the entered data. Consequently, using the method and system for providing a multi-display element interface display with continuously connected data display elements selectable through a single continuous motion discussed herein, fewer processor cycles are utilized for data entry, and the correction of erroneous data entry, memory utilization is also reduced, and less communications bandwidth is utilized to relay data to backend systems. As a result, computing systems, and particularly mobile computing systems, are transformed into faster, more efficient, and more effective computing systems by implementing the method and system for providing a multi-display element interface display with continuously connected data display elements selectable through a single continuous motion discussed herein.

### BRIEF DESCRIPTION OF THE DRAWINGS

FIG. 1 is a block diagram of architecture for providing a method and system for providing a multi-display element interface display with continuously connected data display elements selectable through a single continuous motion in accordance with one embodiment;

FIG. 2 is a flow chart representing one example of a process for providing a multi-display element interface display with continuously connected data display elements selectable through a single continuous motion in accordance with one embodiment;

FIGS. 3A, 3B, 3C, and 3D show the operation of one illustrative example of a multi-display element interface display with continuously connected data display elements in accordance with one embodiment;

FIG. 4 is an illustrative example of a multi-display element interface display with continuously connected data display elements used to select calendar months in accordance with one embodiment;

FIGS. 5A, 5B, and 5C show the operation of one illustrative example of a multi-display element interface display with continuously connected data display elements in accordance with one embodiment; and

FIGS. 6A and 6B show the operation of one illustrative example of two multi-display element interface displays with continuously connected data display elements displayed on a single display screen in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the terms “mobile computing system” and “mobile device” are used interchangeably and include, but are not limited to the following: a smart phone; a cellular phone; a digital wireless telephone; a tablet computing system; a notebook computing system; any portable computing system; a two-way pager; a Personal Digital Assistant (PDA); a media player; an Internet appliance; devices worn or carried by a user; or any other movable/mobile device and/or computing system that includes components that can execute all, or part, of any one of the processes and/or operations as described herein.

Herein, the term “production environment” includes the various components, or assets, used to deploy, implement, access, and use, a given application as that application is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user experience” includes not only the data entry process, but also other user experience features provided or displayed to the user such as, but not limited to the following: interfaces; images; backgrounds; avatars; highlighting mechanisms; icons; and any other features that individually, or in combination, create a user experience, as discussed herein, and/or as known in the art at the time of filing, and/or as developed after the time of filing.

Herein, the term “user” and “user consumer” and “customer” are used interchangeably to denote any party and/or entity that interfaces with, and/or to whom information is provided by, the method and system for providing a multi-display element interface display with continuously connected data display elements selectable through a single continuous motion described herein, and/or a person and/or entity that interfaces with, and/or to whom information is provided by, the method and system for providing a multi-display element interface display with continuously connected data display elements selectable through a single continuous motion described herein, and/or a legal guardian of person and/or entity that interfaces with, and/or to whom information is provided by, the method and system for providing a multi-display element interface display with continuously connected data display elements selectable through a single continuous motion described herein, and/or an authorized agent of any party and/or person and/or entity that interfaces with, and/or to whom information is provided by, the method and system for providing a multi-display element interface display with continuously connected data display elements selectable through a single continuous motion described herein. For instance, in various embodiments, a user can be, but is not limited to, a person, a commercial entity, an application, a service, and/or a computing system.

### Method and System Environment

In one embodiment, a method and system for providing a multi-display element interface display with continuously connected data display elements selectable through a single continuous motion includes defining two or more data elements to be represented by display elements in a multi-display element interface display with continuously connected data display elements.

In various embodiments the data elements can be any data, e.g., machine readable information, instructions, or code, representing information that is to be processed, provided to various modules, recorded and correlated, and/or stored. In one embodiment, the data elements are discrete data sets that can be selected by a user and represent information specific to, applicable to, or to be otherwise associated with, the user if, and when, they are selected by the user.

As specific illustrative examples, the data elements can be machine readable representations of days, calendar dates, weeks, months, or years; email, text, or voice messages; name and contact information; or any other type of discrete data elements as discussed herein, and/or as known in the art at the time of filing, and/or as developed after the time of filing.

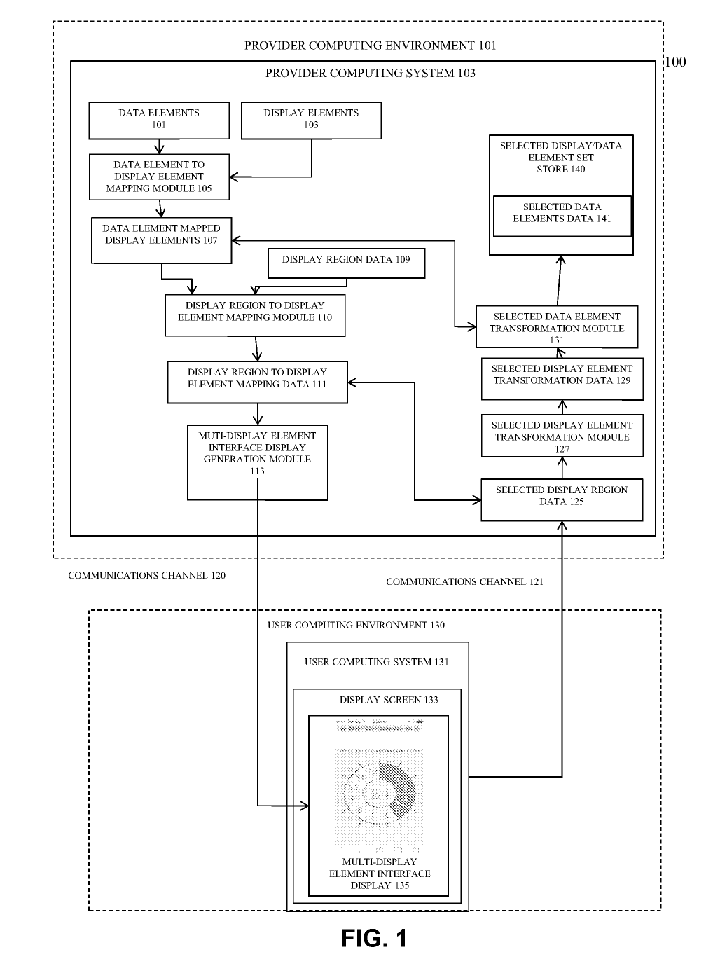

FIG. 1 is a block diagram of a hardware and production environment 100 for, in one embodiment, implementing a method and system for providing a multi-display element interface display with continuously connected data display elements selectable through a single continuous motion. As seen in FIG. 1, hardware and production environment 100 includes provider computing system 103. In various embodiments, provider computing system 103 is a computing system, such as any computing system discussed herein, and/or as known in the art at the time of filing, and/or as developed after the time of filing, that is under the control of, accessible by, or associated with, a provider of the method and system for providing a multi-display element interface display with continuously connected data display elements selectable through a single continuous motion. In various embodiments, provider computing system 103 is implemented or deployed in provider computing environment 101 which can be any computing environment discussed herein, and/or as known in the art at the time of filing, and/or as developed after the time of filing.

As also seen in FIG. 1, provider computing system 103 includes data elements 101 representing a set of defined data elements, such as the data elements discussed above.

In one embodiment, the defined data elements are associated with corresponding display elements that will eventually represent the data elements in a multi-display element interface display with continuously connected data display elements. In various embodiments, the display elements are visual representations of the defined data elements and can be, but are not limited to, text, e.g., alpha-numeric display elements; graphical elements, such as icons, illustrations, symbols, avatars, animation, headers, content derived from the underlying data element, or any other visual representation of data, discussed herein, and/or as known in the art at the time of filing, and/or as developed after the time of filing.

As specific illustrative examples, where the data elements are representations of days, calendar dates, weeks, months, or years, the display elements can be numbers representing a date or dates, abbreviations of days or months, or numbers representing months or years. Where the data elements are email, text, or voice messages, the display elements can be headers in the messages, numbers associated with messages, or text or graphics representing the author of the messages. Where the data elements are names and/or contacts, the display elements can be text and/or graphics representing the name and/or contact information associated with the underlying data elements. As the reader will realize, the possible variations of the data elements defined, and therefore the corresponding display elements generated, is virtually limitless. Consequently, the display elements are not limited to those discussed for illustrative purposes herein, but can be any representation of data, discussed herein, and/or as known in the art at the time of filing, and/or as developed after the time of filing.

In one embodiment, each defined data element is mapped to a corresponding display element such that each display element of the generated multi-display element interface display with selectable data elements is directly associated with an underlying data element in a one-to-one correspondence.

Returning to FIG. 1, as noted above, the defined data elements are represented as data elements 101 in provider computing system 103. In addition data representing the display elements is represented as display elements 103 in provider computing system 103. In one embodiment, data elements 101 are associated in a one-to-one correspondence with display elements 103 by data elements to display element mapping module 105 to generate data element mapped display elements 107.

In one embodiment, once the display elements are generated and associated with an underlying data element, two or more display regions of a multi-display element interface display with continuously connected data display elements are designated. In one embodiment each of the display regions of the multi-display element interface display with continuously connected data display elements are visually positioned in the multi-display element interface display with continuously connected data display elements such that at least a portion of each display region is connected to at least one other display region so that two or more continuously connected display regions can be contacted, or swept over, by a single continuous contact motion, such as a swiping motion, made on a display screen of a computing system displaying the multi-display element interface display with continuously connected data display elements.

In various embodiments, the display regions of the multi-display element interface display with continuously connected data display elements are defined by logically segmenting the multi-display element interface display with continuously connected data display elements into connected display regions. In various embodiments, the display regions can be of any size and/or shape desired.

In one embodiment, once the display regions of the multi-display element interface display with continuously connected data display elements are defined, a specific display element is mapped to a corresponding display region to be displayed in the mapped display region of the multi-display element interface display with continuously connected data display elements that is then generated and displayed on a display screen of a computing system.

Returning to FIG. 1, in one embodiment, the data defining the display regions is represented by display region data 109. As also seen in FIG. 1, data element mapped display elements 107 representing the data elements 101 associated in a one-to-one correspondence with display elements 103 by data elements to display element mapping module 105, are mapped to a corresponding region of display region data 109 by display region to display element mapping module 110 to generate display region to display element mapping data 111.

In one embodiment, display region to display element mapping data 111 is provided to multi-display element interface display generation module 113 which generates the multi-display element interface display with continuously connected data display elements, shown as multi-display element interface display 135 in FIG. 1.

As also seen in FIG. 1, in one embodiment, multi-display element interface display 135 is provided for display on display screen 133 of user computing system 131 in user computing environment 130 via communications channel 120 which commutatively couples provider computing environment 101, and/or provider computing system 103, with user computing environment 130, and/or user computing system 131.

In various embodiments, user computing environment 130 is any computing environment as discussed herein, and/or as known in the art at the time of filing, and/or as developed after the time of filing. In some embodiments, user computing environment 130 is a computing environment that is separate and distinct from provider computing environment 101. In other embodiments, user computing environment 130 and provider computing environment 101 are the same computing environment.

In various embodiments, user computing system 131 is any computing system as discussed herein, and/or as known in the art at the time of filing, and/or as developed after the time of filing. Similarly, communications channel 120 is any communications channel as discussed herein, and/or as known in the art at the time of filing, and/or as developed after the time of filing. In various embodiments, user computing system 131 is any mobile computing system as discussed herein, and/or as known in the art at the time of filing, and/or as developed after the time of filing, under the control of, accessible by, or otherwise associated with, a user of any of the embodiments of the method and system for providing a multi-display element interface display with continuously connected data display elements selectable through a single continuous motion described herein.

In various embodiments, display screen 133 is a “touch screen” or any other form of user interactive display screen that allows a user of user computing system 131 to physically interact with multi-display element interface display 135, as displayed on display screen 133.

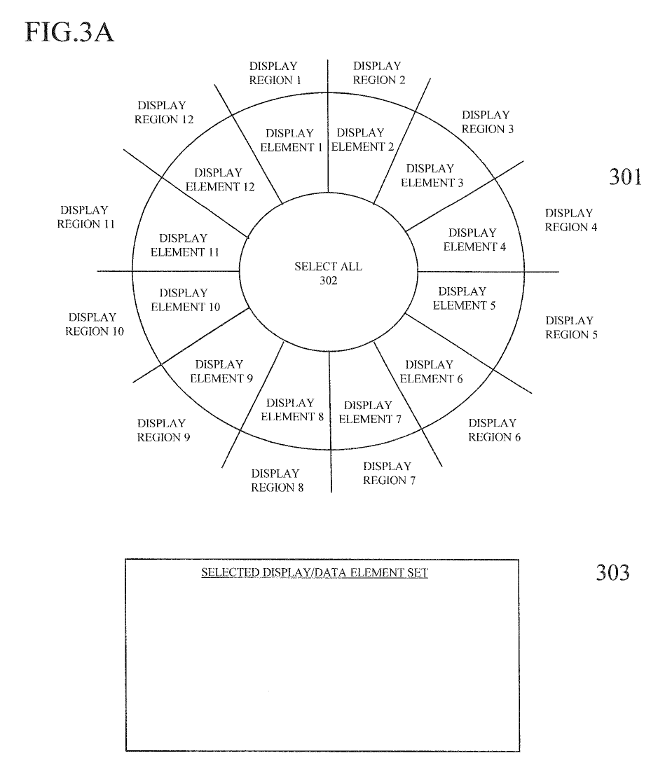

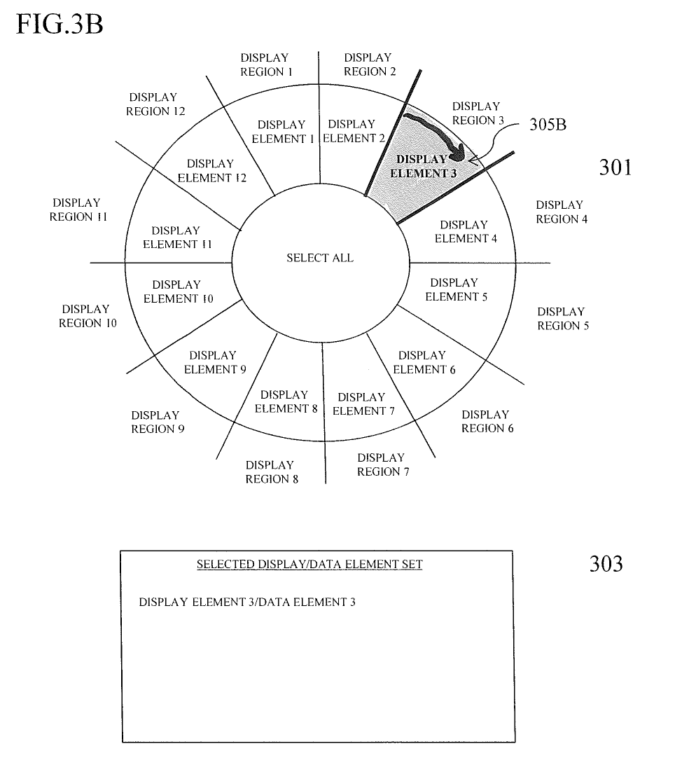

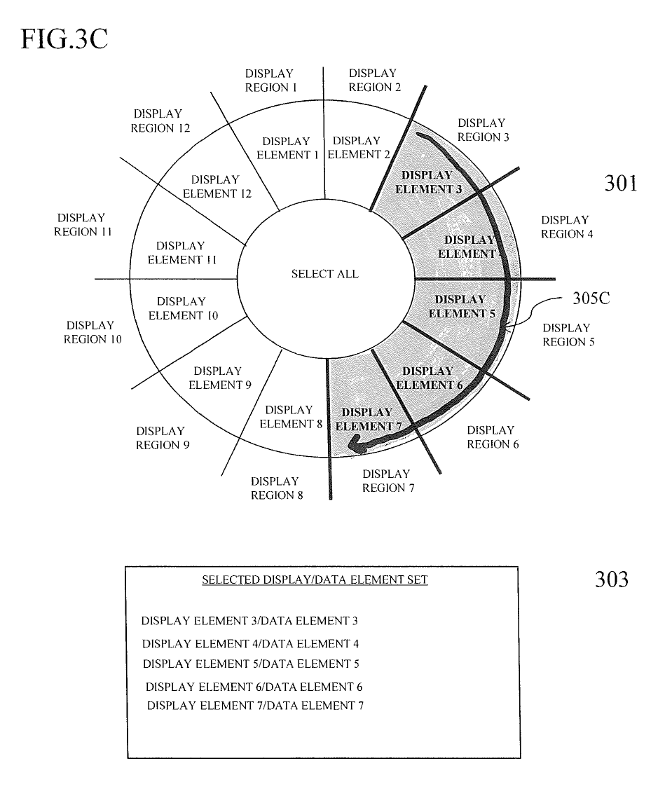

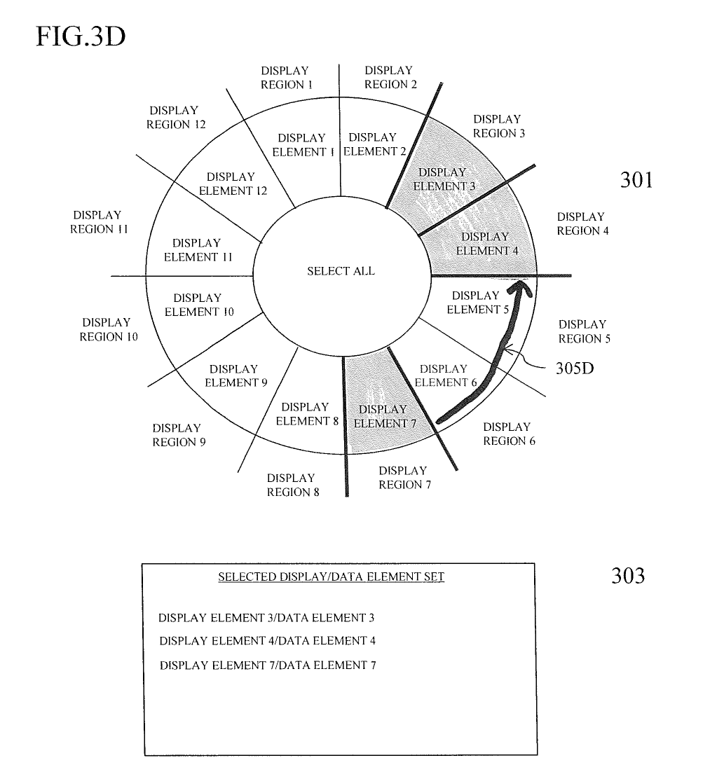

FIG. 3A shows one illustrative example of a multi-display element interface display with continuously connected data display elements 301 as would, in one illustrative embodiment, be displayed on display screen 133 of user computing system 131 of FIG. 1. As seen in FIG. 3A, multi-display element interface display with continuously connected data display elements 301 includes connected display regions 1 through 12 that, in this particular illustrative example, are wedges arranged in a circular pattern around a hub that, in this specific illustrative example, is a select all function display region 302. As also seen in FIG. 3A, each of connected display regions 1 through 12 is in contact with at least one, and in this example three, other connected display regions, i.e., two adjacent connected display regions and the select all function display region 302. As also seen in FIG. 3A, and as discussed below, each connected display region 1 through 12 includes a corresponding connected display element of connected display elements 1 through 12 which, in turn, represents a corresponding defined data element (not shown).

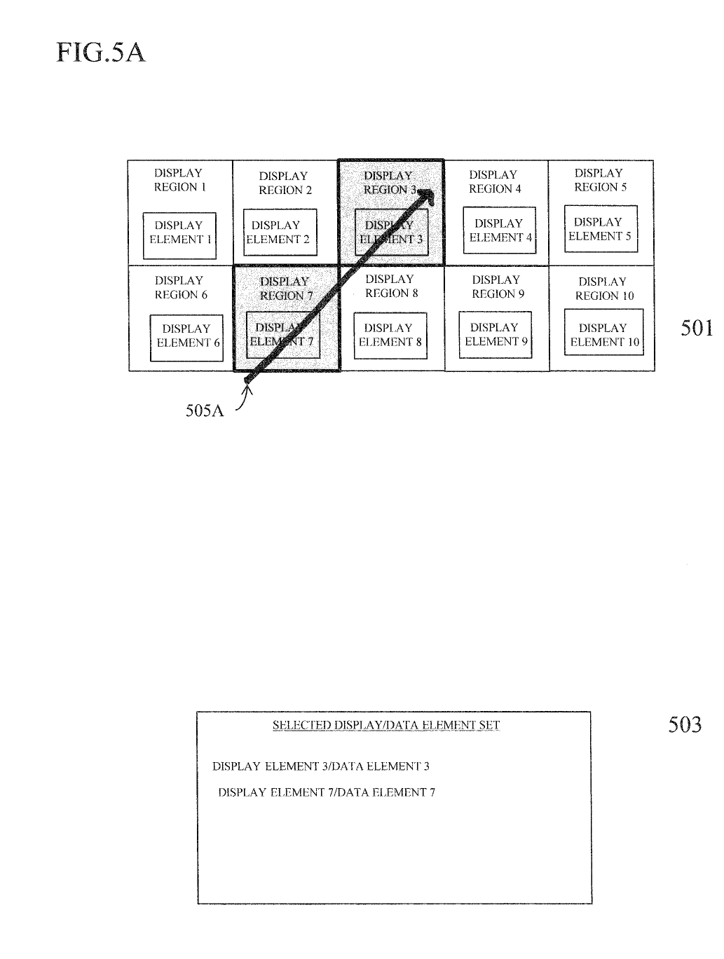

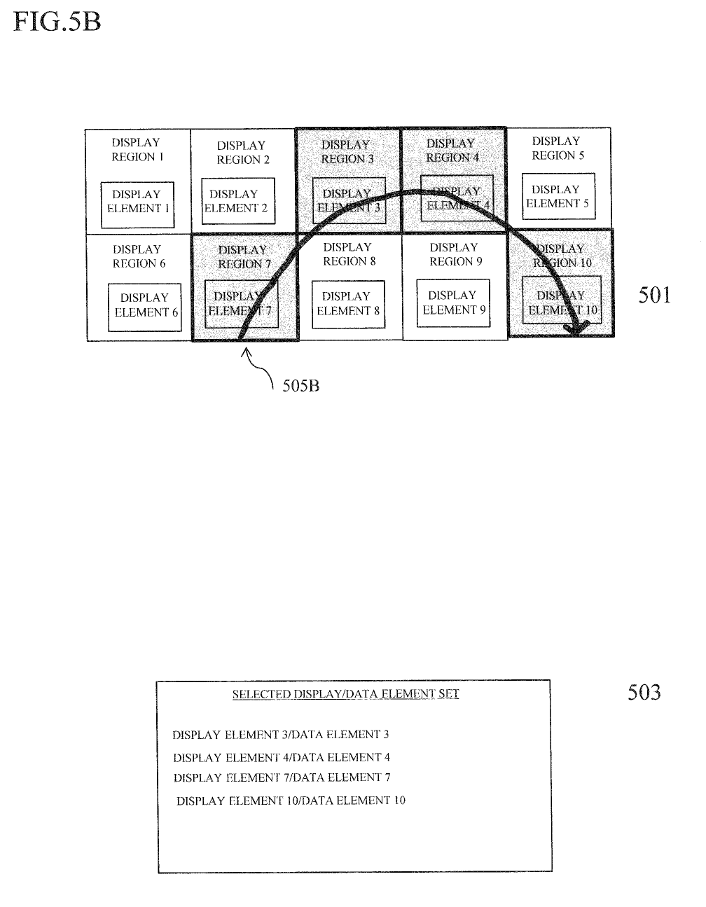

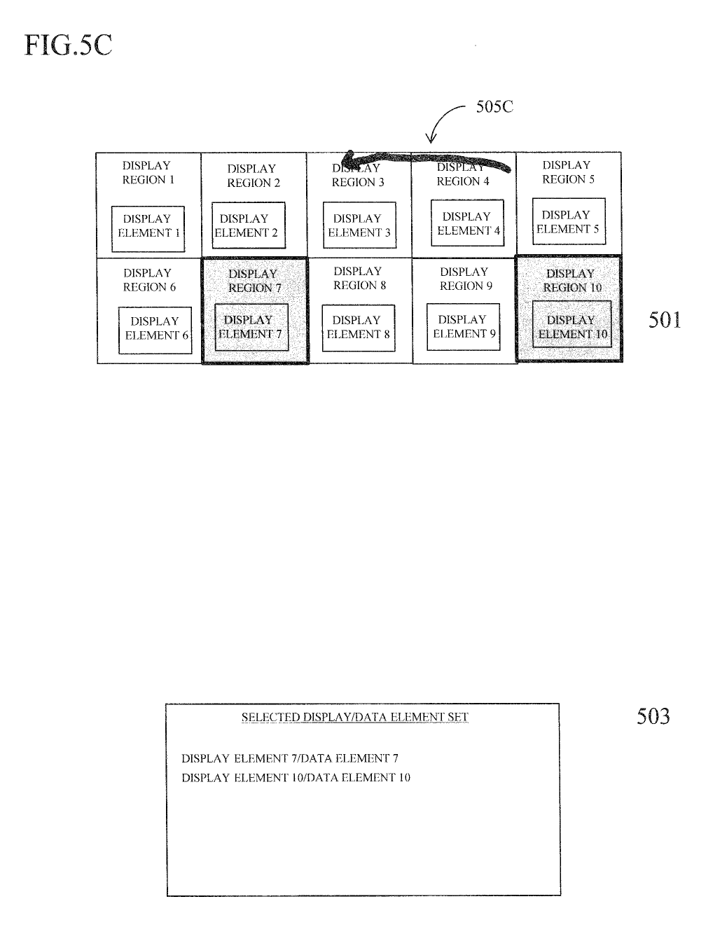

Similarly, FIG. 5A shows one illustrative example of a multi-display element interface display with continuously connected data display elements 501 as would, in one illustrative embodiment, be displayed on display screen 133 of user computing system 131 of FIG. 1. As seen in FIG. 5A, multi-display element interface display with continuously connected data display elements 501 includes connected display regions 1 through 10 that, in this particular illustrative example, are rectangles arranged in a row and column arrangement. As also seen in FIG. 5A, each of connected display regions 1 through 10 is in contact with at least one, and in this example at least three, other connected display regions. As also seen in FIG. 5A, and as discussed below, each connected display region 1 through 10 includes a corresponding connected display element of connected display elements 1 through 10 which, in turn, represents a corresponding defined data element (not shown).

In one embodiment, once the multi-display element interface display with continuously connected data display elements is generated and displayed on a display screen of a computing system, the user is provided access to the multi-display element interface display with continuously connected data display elements on the display screen of the computing system. In one embodiment, the user is then provided the capability to make contact with two or more continuously connected display regions of the connected display regions, and associated continuously connected display elements, in the multi-display element interface display with continuously connected data display elements through a single continuous contact motion with the multi-display element interface display with continuously connected data display elements on the display screen of the computing system.

As noted above, in one embodiment, each of the display regions, including the associated display elements, is arranged in the multi-display element interface display with continuously connected data display elements such that any one display region/display element is displayed as being in contact with at least one other display region/display element. In this way, the user is provided the capability to make contact with, e.g., touch or sweep over, two or more continuously connected display regions/display elements through a single continuous contact motion, e.g., a single swiping motion with a finger or stylus, without having to lift the finger or stylus. Consequently, a subset of two or more continuously connected display elements, and their underlying data elements, can be selected in a single motion, as opposed to the multiple repetitive actions, such as selecting multiple check boxes, required by prior art methods and systems. However, unlike prior art “select all” functions, using the multi-display element interface display with continuously connected data display elements described herein, a subset of desired continuously connected multiple display elements can be selected through the single continuous contact motion without selecting the entire set of display elements, and their underlying data elements.

In one embodiment, for each continuously connected display region contacted by the user's single continuous contact motion with the display screen, the display element corresponding to the contacted display region is transformed into a selected display element. In one embodiment, the data elements associated with each of the selected display elements are then transformed into selected data elements. In one embodiment, the selected data elements are then accumulated in a selected data element set and the selected data element set is stored as selected data.

Returning to FIG. 1, when the user makes contact with, e.g., touches or sweeps over, two or more continuously connected display regions/display elements through a single continuous contact motion, e.g., a single swiping motion with a finger or stylus, on multi-display element interface display 135, selected display region data 125 is generated and transferred to provider computing system 103 via communications channel 121. In various embodiments, communications channel 121 is any communications channel, as discussed herein, and/or as known in the art at the time of filing, and/or as developed after the time of filing.

In one embodiment, at provider computing system 103, selected display region data 125 is compared to display region to display elements mapping module data 111 by selected display element transformation module 127 to generate selected display element transformation data 129 representing the display elements indicated in selected display region data 125.

In one embodiment, selected display element transformation data 129 is provided to selected data element transformation module 131 which compares selected display element transformation data 129 and data element mapped display elements 107 to generate selected data elements data 141 representing the set of selected data elements indicated by selected display region data 125. In one embodiment, selected data elements data 141 is stored in selected display/data element set store 140, In various embodiments, selected display/data element set store 140 is any database or data store, as discussed herein, and/or as known in the art at the time of filing, and/or as developed after the time of filing.

Those of skill in the art will readily recognize that while in the discussion above the method and system for providing a multi-display element interface display with continuously connected data display elements selectable through a single continuous motion is implemented on two computing systems, in two computing environments, in other embodiments, the method and system for providing a multi-display element interface display with continuously connected data display elements selectable through a single continuous motion can be implemented using one computing system, and in one computing environment, or using three or more computing systems, in three or more computing environments. Consequently, the specific illustrative examples discussed herein do not limit the scope of the claims presented below.

FIGS. 3A through 3D show one illustrative example of a multi-display element interface display with continuously connected data display elements 301 as would, in one illustrative embodiment, be displayed on display screen 133 of user computing system 131 of FIG. 1, and as used in accordance with one embodiment.

As discussed above, multi-display element interface display with continuously connected data display elements 301 includes connected display regions 1 through 12 that, in this particular illustrative example, are continuously connected wedges arranged in a circular pattern around a hub that, in this specific illustrative example, is a select all function display region 302. As also seen in FIG. 3A, each of connected display regions 1 through 12 is in contact with at least one, and in this example three, other connected display regions, i.e., two adjacent connected display regions and the select all function display region 302. As also seen in FIG. 3A, and as discussed below, each connected display region 1 through 12 includes a corresponding connected display element of connected display elements 1 through 12 which, in turn, represents a corresponding defined data element (not shown).

As also seen in FIG. 3A, none of the connected display regions/display elements 1 through 12 have yet been selected. Consequently, selected display/data element set 303 is shown as empty. However, as seen in FIG. 3B, when a user performs a single continuous contact motion, e.g., a single swiping motion with a finger or stylus, depicted by arrow 305B in FIG. 3B, connected display region 3 is contacted and connected display element 3 is selected. Consequently, the data element corresponding to connected display element 3, in this example, data element 3, is transformed into a selected data element and added to the selected data element set of selected display/data element set 303.

As seen in FIG. 3C, as the user continues to perform the single continuous contact motion, e.g., a single swiping motion with a finger or stylus, depicted by arrow 305C in FIG. 3C, continuously connected display regions 3, 4, 5, 6, and 7 are contacted and continuously connected display elements 3, 4, 5, 6, and 7 are selected. Consequently, the data elements corresponding to continuously connected display elements 3, 4, 5, 6, and 7, in this example data elements 3, 4, 5, 6, and 7, are transformed into selected data elements and accumulated in the selected data element set of selected display/data element set 303. Therefore, using the method and system for providing a multi-display element interface display with continuously connected data display elements selectable through a single continuous motion disclosed herein, the user is provided the capability to make contact with, e.g., touch or sweep over, continuously connected display regions 3, 4, 5, 6, and 7, and therefore continuously connected display elements 3, 4, 5, 6, and 7, through a single continuous contact motion 305C, e.g., a single swiping motion with a finger or stylus, without having to lift the finger or stylus. Consequently, the subset of continuously connected display elements 3, 4, 5, 6, and 7, and their underlying data elements 3, 4, 5, 6, and 7, are selected in a single continuous contact motion, as opposed to the multiple repetitive actions, such as selecting multiple check boxes, required by prior art methods and systems. However, unlike prior art select all functions, using multi-display element interface display with continuously connected data display elements 301, the subset of continuously connected display elements 3, 4, 5, 6, and 7, and their underlying data elements 3, 4, 5, 6, and 7, are selected through the single continuous contact motion without selecting the entire set of connected display elements 1 through 12, and their underlying data elements 1 through 12.

In addition, in one embodiment, once a subset of continuously connected display elements, and underlying data elements have been selected, a subset of one of more previously selected continuously connected display elements can be “deselected” through a second single continuous contact motion. FIG. 3D shows previously selected continuously connected display elements 5 and 6 from FIG. 3C, and their underlying data elements 5 and 6, being deselected from the previously selected subset of continuously connected display elements 3, 4, 5, 6, and 7 via a second single continuous contact motion depicted by arrow 305D. In this example, continuously connected display elements 5 and 6 are thereby deselected and data elements 5 and 6 are removed from the selected data elements accumulated in the selected data element set of selected display/data element set 303.

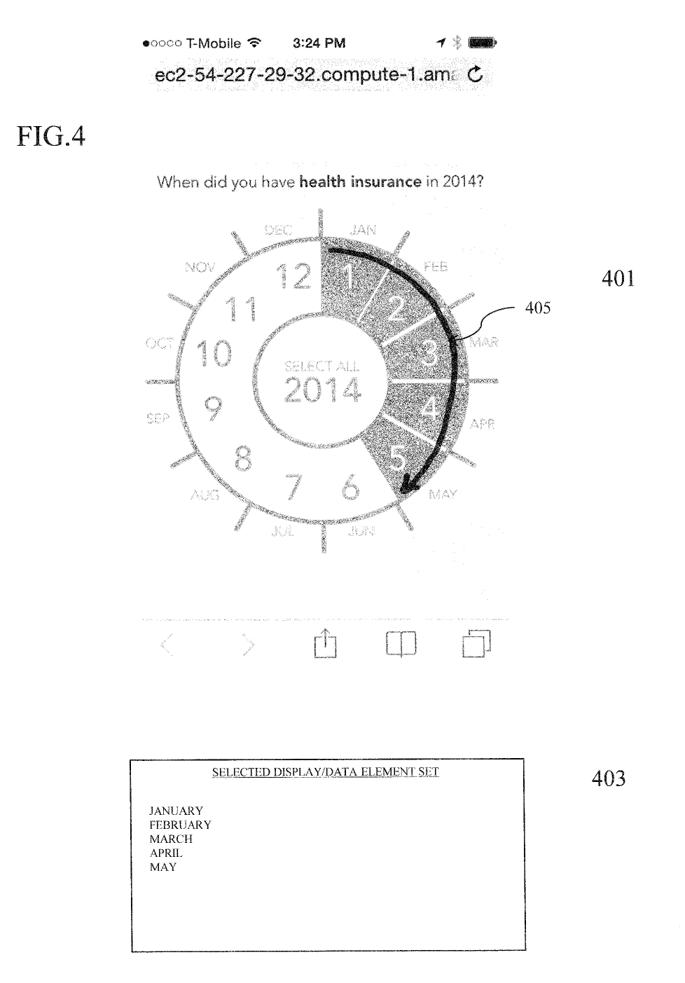

FIG. 4 shows an illustrative example of a multi-display element interface display with continuously connected data display elements 401 that includes connected display regions JAN, FEB, MAR, APR, MAY, JUN, JUL, AUG, SEP, OCT, NOV, and DEC, corresponding to the 12 months of the year 2014 and, that in this particular illustrative example, are continuously connected wedges arranged in a circular pattern around a hub that, in this specific illustrative example, is a select all function display region. In the specific illustrative example of FIG. 4, each of the connected display regions includes a corresponding connected display element 1 to 12 that, in turn, is associated with each month JAN(1), FEB(2), MAR(3), APR(4), MAY(5), JUN(6), JUL(7), AUG(8), SEP(9), OCT(10), NOV(11), and DEC(12). In this specific example, the select all function display region corresponds to the entire year 2014, i.e., all 12 months for 2014.

As seen in FIG. 4, in this illustrative example, as the user performs the single continuous contact motion, e.g., a single swiping motion with a finger or stylus, depicted by arrow 405 in FIG. 4, continuously connected display regions JAN, FEB, MAR, APR, and MAY are contacted and continuously connected display elements 1, 2, 3, 4, and 5 are selected. Consequently, the data elements corresponding to continuously connected display elements 1, 2, 3, 4, and 5, in this example data elements January, February, March, April and May, are transformed into selected data elements and accumulated in the selected data element set of selected display/data element set 403. Therefore, through multi-display element interface display with continuously connected data display elements 401, the user is provided the capability to make contact with, e.g., touch or sweep through, continuously connected display regions JAN, FEB, MAR, APR, and MAY, and therefore continuously connected display elements 1, 2, 3, 4, and 5, via a single continuous contact motion 405, e.g., a single swiping motion with a finger or stylus, without having to lift the finger or stylus. Consequently, the subset of continuously connected display elements 1, 2, 3, 4, and 5, and their underlying data elements January, February, March, April and May, are selected in a single continuous contact motion, as opposed to the multiple repetitive actions, such as selecting 5 multiple display elements individually, required by prior art methods and systems. However, unlike prior art select all functions, using multi-display element interface display with continuously connected data display elements 401, the subset of continuously connected display elements 1, 2, 3, 4, and 5, and their underlying data elements January, February, March, April and May, are selected through the single continuous contact motion without selecting the entire set of connected display elements 1 through 12, and their underlying data elements representing the entire calendar year 2014.

FIGS. 5A through 5C show one illustrative example of another multi-display element interface display with continuously connected data display elements 501 as would, in one illustrative embodiment, be displayed on display screen 133 of user computing system 131 of FIG. 1, and as used in accordance with one embodiment.

As discussed above, multi-display element interface display with continuously connected data display elements 501 includes connected display regions 1 through 10 that, in this particular illustrative example, are rectangles arranged in a column and row pattern. As also seen in FIG. 5A, each of connected display regions 1 through 10 is in contact with at least one, and in this example at least three, other connected display regions. As also seen in FIG. 5A, and as discussed below, each connected display region 1 through 10 includes a corresponding connected display element of connected display elements 1 through 10 which, in turn, represents a corresponding defined data element (not shown).

As also seen in FIG. 5A, two of the connected display regions/display elements 1 through 12, i.e., continuously connected display elements 3 and 7, are shown as being selected through a single continuous diagonal contact motion, e.g., a single swiping motion with a finger or stylus, depicted by arrow 505A in FIG. 5A. Consequently, the data elements corresponding to display elements 3 and 7, in this example data elements 3 and 7, are transformed into selected data elements and accumulated in the selected data element set of selected display/data element set 503.

As seen in FIG. 5B, as the user continues to perform a single continuous curving contact motion, e.g., a single curved motion with a finger or stylus, depicted by arrow 505B in FIG. 5B, continuously connected display regions 3, 4, 7, and 10 are contacted and continuously connected display elements 3, 4, 7, and 10 are selected. Consequently, the data elements corresponding to continuously connected display elements 3, 4, 7, and 10, in this example data elements 3, 4, 7, and 10, are transformed into selected data elements and accumulated in the selected data element set of selected display/data element set 503. Therefore, using multi-display element interface display with continuously connected data display elements 501, the user is provided the capability to make contact with, e.g., touch or sweep over, continuously connected display regions 3, 4, 7, and 10, and therefore continuously connected display elements 3, 4, 7, and 10, via a single continuous contact motion 505B, e.g., a single curving motion with a finger or stylus, without having to lift the finger or stylus. Consequently, the subset of continuously connected display elements 3, 4, 7, and 10, and their underlying data elements 3, 4, 7, and 10, are selected in a single continuous contact motion, as opposed to the multiple repetitive actions, such as selecting multiple boxes, required by prior art methods and systems. However, unlike prior art select all functions, using multi-display element interface display with continuously connected data display elements 501, the subset of continuously connected display elements 3, 4, 7, and 10, and their underlying data elements 3, 4, 7, and 10, are selected through the single continuous contact motion without selecting the entire set of connected display elements 1 through 10, and their underlying data elements 1 through 10.

In addition, in one embodiment, once a subset of continuously connected display elements, and underlying data elements, have been selected, a subset of one of more previously selected continuously connected display elements can be “deselected” through a second single continuous contact motion. FIG. 5C shows continuously connected display elements 3 and 4, and their underlying data elements 3 and 4, being deselected from the previously selected subset of continuously connected display elements 3, 4, 7, and 10 of FIG. 5B via a second single continuous contact motion depicted by arrow 505C. In this example, continuously connected display elements 3 and 4 are thereby deselected and data elements 3 and 4 are removed from the selected data elements accumulated in the selected data element set of selected display/data element set 503.

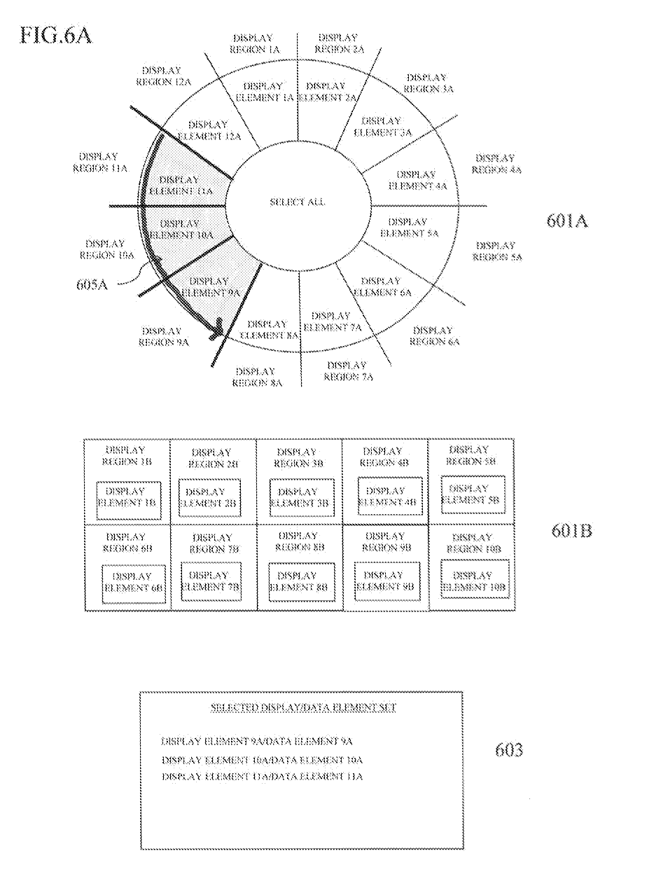

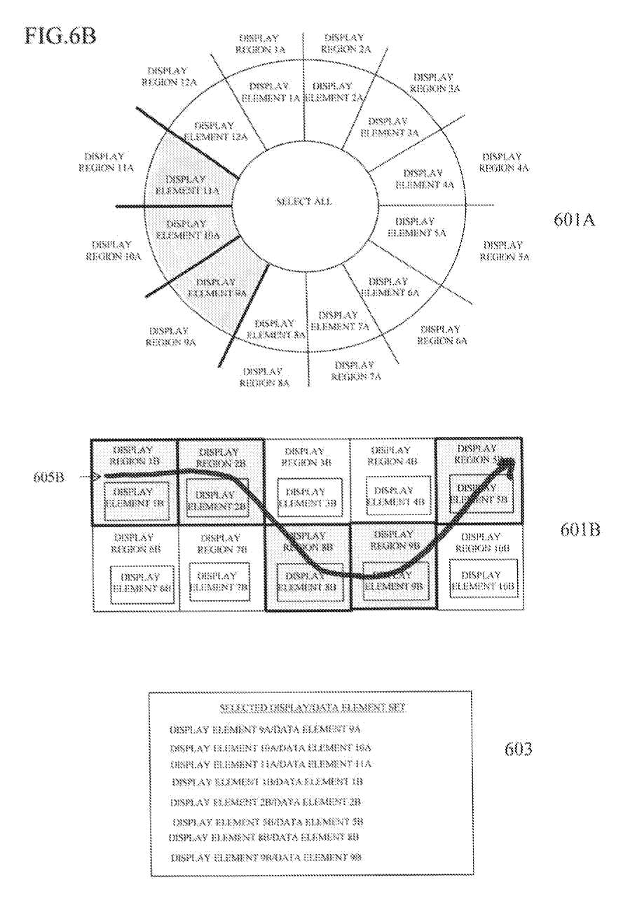

In some embodiments, two or more multi-display element interface displays with continuously connected data display elements are displayed in a single display screen and continuously connected display elements can be selected from the two or more multi-display element interface displays with continuously connected data display elements to be combined into a single accumulated set of selected display/data elements. FIGS. 6A and 6B illustrate one example of two or more multi-display element interface displays with continuously connected data display elements 601A and 601B as would, in one illustrative embodiment, be displayed on display screen 133 of user computing system 131 of FIG. 1, and as used in accordance with one embodiment.

As seen in FIG. 6A, as the user performs a first single continuous contact motion, e.g., a single swiping motion with a finger or stylus, depicted by arrow 605A in FIG. 6A, continuously connected display regions 9A, 10A, and 11A are contacted and continuously connected display elements 9A, 10A, and 11A are selected. Consequently, the data elements corresponding to continuously connected display elements 9A, 10A, and 11A, in this example data elements 9A, 10A, and 11A, are transformed into selected data elements and accumulated in the selected data element set of selected display/data element set 603.

As seen in FIG. 6B, once continuously connected display elements 9A, 10A, and 11A are selected and data elements 9A, 10A, and 11A are transformed into selected data elements by the first single continuous contact motion of FIG. 6A, the user performs a second continuous contact motion in FIG. 6B, e.g., a single winding or snaking motion with a finger or stylus, depicted by arrow 605B in FIG. 6B. Through this second continuous contact motion continuously connected display regions 1B, 2B, 5B, 8B, and 9B are contacted and continuously connected display elements 1B, 2B, 5B, 8B, and 9B are selected. Consequently, the data elements corresponding to continuously connected display elements 1B, 2B, 5B, 8B, and 9B, in this example data elements 1B, 2B, 5B, 8B, and 9B, are transformed into selected data elements and accumulated and added to the selected data element set of selected display/data element set 603. Therefore, using multi-display element interface display with continuously connected data display elements 601A and 601B as disclosed herein, the user is provided the capability to make contact with, e.g., touch or sweep over, continuously connected display regions 9A, 10A, and 11A, and continuously connected display regions 1B, 2B, 5B, 8B, and 9B, and therefore connected display elements 9A, 10A, 11A, 1B, 2B, 5B, 8B, and 9B, via only two continuous contact motions 605A and 605B with a finger or stylus. Consequently, the subset of connected display elements 9A, 10A, 11A, 1B, 2B, 5B, 8B, and 9B, and their underlying data elements 9A, 10A, 11A, 1B, 2B, 5B, 8B, and 9B, are selected and merged into a selected data set by only two continuous contact motions, as opposed to the 8 or more repetitive actions, such as selecting multiple boxes, required by prior art methods and systems. However, unlike prior art select all functions, using multi-display element interface display with selectable data elements 601A and 601B, as described herein, the subset of connected display elements 9A, 10A, 11A, 1B, 2B, 5B, 8B, and 9B, and their underlying data elements 9A, 10A, 11A, 1B, 2B, 5B, 8B, and 9B, are selected through the two continuous contact motions without selecting the entire set of connected display elements 1A through 12A and 1B through 10B, and their underlying data elements 1A through 12A and 1B through 10B.

In one embodiment, using the method and system for providing a multi-display element interface display with continuously connected data display elements selectable through a single continuous motion discussed herein, a solution to the long standing problem of providing an efficient method and system to select a desired subset of display elements through a multi-display element interface display is provided that significantly improves the technical fields of data entry/selection and user experience. Specifically, a user's experience is improved and simplified using embodiments of the present disclosure so that the user experience is less burdensome and the user can dedicate more of his or her time to other activities. Therefore, implementations of embodiments of the present disclosure represent a significant improvement to the field of user experience and, in particular, efficient use of human and non-human resources.

In addition, by eliminating the necessity of individually selecting each desired display element in a multi-display element interface display there are fewer data entry actions to process, and fewer errors in the entered data. Consequently, using the method and system for providing a multi-display element interface display with continuously connected data display elements selectable through a single continuous motion discussed herein, fewer processor cycles are utilized for data entry, and the correction of erroneous data entry, memory utilization is also reduced, and less communications bandwidth is utilized to relay data to backend systems. As a result, computing systems, and particularly mobile computing systems, are transformed into faster, more efficient, and more effective computing systems by implementing the method and system for providing a multi-display element interface display with continuously connected data display elements selectable through a single continuous motion discussed herein.

### Process

In one embodiment, a process for providing a multi-display element interface display with continuously connected data display elements selectable through a single continuous motion address some of the shortcomings associated with prior art multi-display element interface displays by providing visually connected display elements, representing data elements, in a multi-display element interface display with continuously connected data display elements that can be selected, in any order or subset grouping of continuously connected display elements, through a single continuous contact with the display screen displaying the multi-display element interface display with continuously connected data display elements.

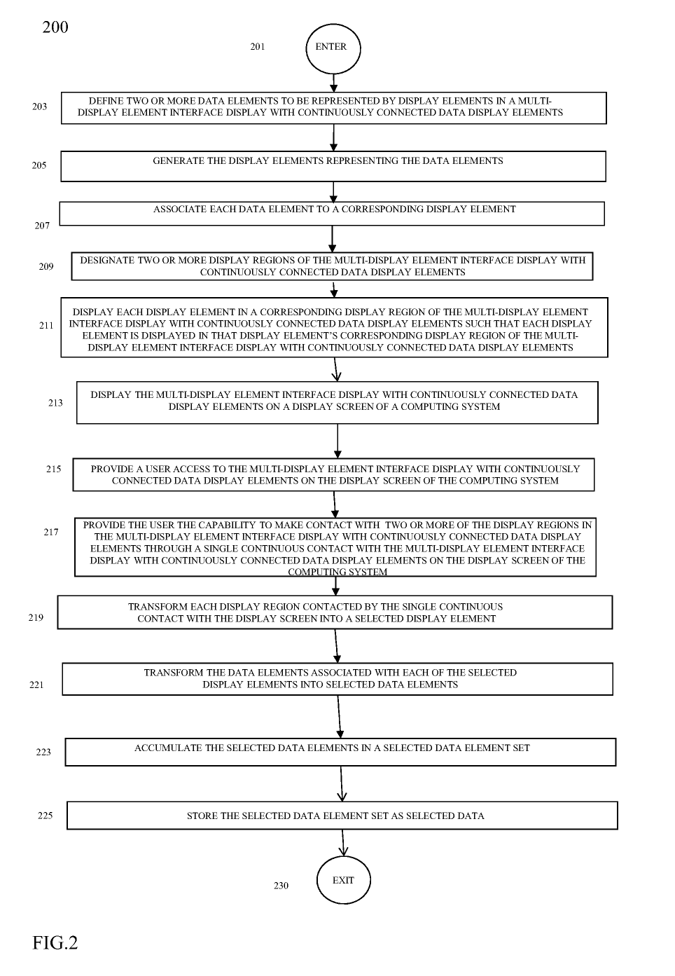

FIG. 2 is a flow chart representing one example of a process 200 for providing a multi-display element interface display with continuously connected data display elements selectable through a single continuous motion in accordance with one embodiment.

As seen in FIG. 2, process 200 for providing a multi-display element interface display with continuously connected data display elements selectable through a single continuous motion begins at ENTER OPERATION 201 and process flow proceeds to DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203.

In one embodiment, at DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 two or more data elements to be represented by connected display elements in a multi-display element interface display with continuously connected data display elements are defined.

In various embodiments, the data elements of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 can be any data, e.g., machine readable information, instructions, or code, representing information that is to be processed, recorded, or stored. In one embodiment, the data elements of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 are discrete data sets that can be selected by a user and represent information specific to, applicable to, or to be otherwise associated with, the user once selected.

As specific illustrative examples, the data elements of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 can be machine readable representations of days, calendar dates, weeks, months, or years; email, text, or voice messages; name and contact information; or any other type of discrete data elements as discussed herein, and/or as known in the art at the time of filing, and/or as developed after the time of filing.

In one embodiment, once two or more data elements to be represented by display elements in a multi-display element interface display with continuously connected data display elements are defined at DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203, process flow proceeds to GENERATE THE DISPLAY ELEMENTS REPRESENTING THE DATA ELEMENTS OPERATION 205.

In one embodiment, at GENERATE THE DISPLAY ELEMENTS REPRESENTING THE DATA ELEMENTS OPERATION 205 the defined data elements of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 are associated with corresponding display elements that will eventually represent the data elements in a multi-display element interface display with continuously connected data display elements.

In various embodiments, the display elements of GENERATE THE DISPLAY ELEMENTS REPRESENTING THE DATA ELEMENTS OPERATION 205 are visual representations of the defined data elements of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 and can be, but are not limited to: text, e.g., alpha-numeric display elements; graphical elements, such as icons, illustrations, symbols, avatars, animation, headers, content derived from the underlying data element, or any other visual representation of data, discussed herein, and/or as known in the art at the time of filing, and/or as developed after the time of filing.

As specific illustrative examples, where the data elements of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 are representations of days, calendar dates, weeks, months, or years, the display elements of GENERATE THE DISPLAY ELEMENTS REPRESENTING THE DATA ELEMENTS OPERATION 205 can be numbers representing a date or dates, abbreviations of days or months, or numbers representing months or years. Where the data elements of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 are email, text, or voice messages, the display elements of GENERATE THE DISPLAY ELEMENTS REPRESENTING THE DATA ELEMENTS OPERATION 205 can be headers in the messages, numbers associated with messages, or text or graphics representing the author of the messages. Where the data elements of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 are names and/or contacts, the display elements of GENERATE THE DISPLAY ELEMENTS REPRESENTING THE DATA ELEMENTS OPERATION 205 can be text and/or graphics representing the name and contact information associated with the underlying data elements.

As the reader will realize, the possible variations of the data elements defined at DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203, and therefore the corresponding display elements of GENERATE THE DISPLAY ELEMENTS REPRESENTING THE DATA ELEMENTS OPERATION 205, is virtually limitless. Consequently, the display elements are not limited to those discussed for illustrative purposes herein, but can be any representation of data, as discussed herein, and/or as known in the art at the time of filing, and/or as developed after the time of filing.

In one embodiment, once the defined data elements of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 are associated with corresponding display elements that will eventually represent the data elements in a multi-display element interface display with continuously connected data display elements at GENERATE THE DISPLAY ELEMENTS REPRESENTING THE DATA ELEMENTS OPERATION 205, process flow proceeds to ASSOCIATE EACH DATA ELEMENT TO A CORRESPONDING DISPLAY ELEMENT OPERATION 207.

In one embodiment, at ASSOCIATE EACH DATA ELEMENT TO A CORRESPONDING DISPLAY ELEMENT OPERATION 207 each defined data element of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 is mapped to a corresponding display element of GENERATE THE DISPLAY ELEMENTS REPRESENTING THE DATA ELEMENTS OPERATION 205 such that each display element of GENERATE THE DISPLAY ELEMENTS REPRESENTING THE DATA ELEMENTS OPERATION 205 of the generated multi-display element interface display with selectable data elements is directly associated with an underlying data element of DEFINE TWO OR MORE DATA ELEMENTS TO BE REPRESENTED BY DISPLAY ELEMENTS IN A MULTI-DISPLAY ELEMENT INTERFACE DISPLAY WITH CONTINUOUSLY CONNECTED DATA DISPLAY ELEMENTS OPERATION 203 in a one-to-one correspondence.

In one embodiment, once each defined data element is mapped to a corresponding display element such that each display element of the generated multi-display element interface display with selectable data elements is directly associated with an underlying data element in a one-to-one correspondence at ASSOCIATE EACH DATA ELEMENT TO A CORRESPONDING DISPLAY ELEMENT OPERATION 207, process flow proceeds to DESIGNATE TWO OR MORE DISPLAY REGIONS OF THE MULTI-DISPLAY ELEMENT INTERFACE DISPLAY WITH CONTINUOUSLY CONNECTED DATA DISPLAY ELEMENTS OPERATION 209.

In one embodiment, at DESIGNATE TWO OR MORE DISPLAY REGIONS OF THE MULTI-DISPLAY ELEMENT INTERFACE DISPLAY WITH CONTINUOUSLY CONNECTED DATA DISPLAY ELEMENTS OPERATION 209 two or more display regions of a multi-display element interface display with continuously connected data display elements are designated.

In one embodiment, at DESIGNATE TWO OR MORE DISPLAY REGIONS OF THE MULTI-DISPLAY ELEMENT INTERFACE DISPLAY WITH CONTINUOUSLY CONNECTED DATA DISPLAY ELEMENTS OPERATION 209 each of the display regions of the multi-display element interface display with continuously connected data display elements are physically positioned in the multi-display element interface display with continuously connected data display elements such that at least a portion of each display region is visually and/or logically connected to at least one other display region so that two or more continuously connected display regions can be contacted, or swept over, by a single contact motion, such as a swiping motion, made on a display screen of a computing system displaying the multi-display element interface display with continuously connected data display elements.

In various embodiments, the display regions of the multi-display element interface display with continuously connected data display elements are defined at DESIGNATE TWO OR MORE DISPLAY REGIONS OF THE MULTI-DISPLAY ELEMENT INTERFACE DISPLAY WITH CONTINUOUSLY CONNECTED DATA DISPLAY ELEMENTS OPERATION 209 by logically segmenting the multi-display element interface display with continuously connected data display elements into connected display regions. In various embodiments, the display regions can be of any size and/or shape desired.

In one embodiment, once two or more display regions of a multi-display element interface display with continuously connected data display elements are designated at DESIGNATE TWO OR MORE DISPLAY REGIONS OF THE MULTI-DISPLAY ELEMENT INTERFACE DISPLAY WITH CONTINUOUSLY CONNECTED DATA DISPLAY ELEMENTS OPERATION 209 process flow proceeds to DISPLAY EACH DISPLAY ELEMENT IN A CORRESPONDING DISPLAY REGION OF THE MULTI-DISPLAY ELEMENT INTERFACE DISPLAY WITH CONTINUOUSLY CONNECTED DATA DISPLAY ELEMENTS SUCH THAT EACH DISPLAY ELEMENT IS DISPLAYED IN THAT DISPLAY ELEMENT'S CORRESPONDING DISPLAY REGION OF THE MULTI-DISPLAY ELEMENT INTERFACE DISPLAY WITH CONTINUOUSLY CONNECTED DATA DISPLAY ELEMENTS OPERATION 211.

In one embodiment, at DISPLAY EACH DISPLAY ELEMENT IN A CORRESPONDING DISPLAY REGION OF THE MULTI-DISPLAY ELEMENT INTERFACE DISPLAY WITH CONTINUOUSLY CONNECTED DATA DISPLAY ELEMENTS SUCH THAT EACH DISPLAY ELEMENT IS DISPLAYED IN THAT DISPLAY ELEMENT'S CORRESPONDING DISPLAY REGION OF THE MULTI-DISPLAY ELEMENT INTERFACE DISPLAY WITH CONTINUOUSLY CONNECTED DATA DISPLAY ELEMENTS OPERATION 211 a specific display element of GENERATE THE DISPLAY ELEMENTS REPRESENTING THE DATA ELEMENTS OPERATION 205 is mapped to a corresponding display region of DESIGNATE TWO OR MORE DISPLAY REGIONS OF THE MULTI-DISPLAY ELEMENT INTERFACE DISPLAY WITH CONTINUOUSLY CONNECTED DATA DISPLAY ELEMENTS OPERATION 209 to be displayed in the mapped display region of DESIGNATE TWO OR MORE DISPLAY REGIONS OF THE MULTI-DISPLAY ELEMENT INTERFACE DISPLAY WITH CONTINUOUSLY CONNECTED DATA DISPLAY ELEMENTS OPERATION 209 in the multi-display element interface display with continuously connected data display elements that is generated and displayed on a display screen of a computing system.

In one embodiment, once a specific display element is mapped to a corresponding display region to be displayed in the mapped display region in the multi-display element interface display with continuously connected data display elements that is generated and displayed on a display screen of a computing system at DISPLAY EACH DISPLAY ELEMENT IN A CORRESPONDING DISPLAY REGION OF THE MULTI-DISPLAY ELEMENT INTERFACE DISPLAY WITH CONTINUOUSLY CONNECTED DATA DISPLAY ELEMENTS SUCH THAT EACH DISPLAY ELEMENT IS DISPLAYED IN THAT DISPLAY ELEMENT'S CORRESPONDING DISPLAY REGION OF THE MULTI-DISPLAY ELEMENT INTERFACE DISPLAY WITH CONTINUOUSLY CONNECTED DATA DISPLAY ELEMENTS OPERATION 211, process flow proceeds to DISPLAY THE MULTI-DISPLAY ELEMENT INTERFACE DISPLAY WITH CONTINUOUSLY CONNECTED DATA DISPLAY ELEMENTS ON A DISPLAY SCREEN OF A COMPUTING SYSTEM OPERATION 213.

In one embodiment, at DISPLAY THE MULTI-DISPLAY ELEMENT INTERFACE DISPLAY WITH CONTINUOUSLY CONNECTED DATA DISPLAY ELEMENTS ON A DISPLAY SCREEN OF A COMPUTING SYSTEM OPERATION 213 the multi-display element interface display with continuously connected data display elements is generated and displayed on a display screen of a computing system.

In one embodiment, once the multi-display element interface display with continuously connected data display elements is generated and displayed on a display screen of a computing system at DISPLAY THE MULTI-DISPLAY ELEMENT INTERFACE DISPLAY WITH CONTINUOUSLY CONNECTED DATA DISPLAY ELEMENTS ON A DISPLAY SCREEN OF A COMPUTING SYSTEM OPERATION 213, process flow proceeds to PROVIDE A USER ACCESS TO THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 215.

In one embodiment, at PROVIDE A USER ACCESS TO THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 215 a user is provided access to the multi-display element interface display with continuously connected data display elements on the display screen of the computing system.

In one embodiment, once a user is provided access to the multi-display element interface display with continuously connected data display elements on the display screen of the computing system at PROVIDE A USER ACCESS TO THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 215, process flow proceeds to PROVIDE THE USER THE CAPABILITY TO MAKE CONTACT WITH TWO OR MORE OF THE DISPLAY REGIONS IN THE MULTI-DISPLAY ELEMENT INTERFACE DISPLAY WITH CONTINUOUSLY CONNECTED DATA DISPLAY ELEMENTS THROUGH A SINGLE CONTINUOUS CONTACT WITH THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 217.

In one embodiment, at PROVIDE THE USER THE CAPABILITY TO MAKE CONTACT WITH TWO OR MORE OF THE DISPLAY REGIONS IN THE MULTI-DISPLAY ELEMENT INTERFACE DISPLAY WITH CONTINUOUSLY CONNECTED DATA DISPLAY ELEMENTS THROUGH A SINGLE CONTINUOUS CONTACT WITH THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 217 the user of PROVIDE A USER ACCESS TO THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 215 is provided the capability to make contact with two or more continuously connected display regions, and associated continuously connected display elements, in the multi-display element interface display with continuously connected data display elements through a single continuous contact motion with multi-display element interface display on the display screen of the computing system.

As noted above, in one embodiment, each of the display regions of DESIGNATE TWO OR MORE DISPLAY REGIONS OF THE MULTI-DISPLAY ELEMENT INTERFACE DISPLAY WITH CONTINUOUSLY CONNECTED DATA DISPLAY ELEMENTS OPERATION 209, including the associated display elements of GENERATE THE DISPLAY ELEMENTS REPRESENTING THE DATA ELEMENTS OPERATION 205, is arranged in the multi-display element interface display with continuously connected data display elements such that any one display region/display element is displayed as being in contact with at least one other display region/display element. In this way, at PROVIDE THE USER THE CAPABILITY TO MAKE CONTACT WITH TWO OR MORE OF THE DISPLAY REGIONS IN THE MULTI-DISPLAY ELEMENT INTERFACE DISPLAY WITH CONTINUOUSLY CONNECTED DATA DISPLAY ELEMENTS THROUGH A SINGLE CONTINUOUS CONTACT WITH THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 217 the user is provided the capability to make contact with, e.g., touch, two or more continuously connected display regions/display elements through a single continuous contact motion, e.g., a single swiping motion with a finger or stylus, without having to lift the finger or stylus.

Consequently, at PROVIDE THE USER THE CAPABILITY TO MAKE CONTACT WITH TWO OR MORE OF THE DISPLAY REGIONS IN THE MULTI-DISPLAY ELEMENT INTERFACE DISPLAY WITH CONTINUOUSLY CONNECTED DATA DISPLAY ELEMENTS THROUGH A SINGLE CONTINUOUS CONTACT WITH THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 217 a subset of two or more continuously connected display elements, and their underlying data elements, can be selected in a single motion, as opposed to the multiple repetitive actions, such as selecting multiple check boxes, required by prior art methods and systems. However, unlike prior art “select all” functions, using the multi-display element interface display with continuously connected data display elements of DISPLAY THE MULTI-DISPLAY ELEMENT INTERFACE DISPLAY WITH CONTINUOUSLY CONNECTED DATA DISPLAY ELEMENTS ON A DISPLAY SCREEN OF A COMPUTING SYSTEM OPERATION 213 described herein, a subset of desired continuously connected multiple display elements can be selected through the single continuous contact motion without selecting the entire set of display elements, and their underlying data elements.

In one embodiment, once the user is provided the capability to make contact with two or more continuously connected display regions, and associated continuously connected display elements, in the multi-display element interface display with continuously connected data display elements through a single continuous contact motion with multi-display element interface display on the display screen of the computing system at PROVIDE THE USER THE CAPABILITY TO MAKE CONTACT WITH TWO OR MORE OF THE DISPLAY REGIONS IN THE MULTI-DISPLAY ELEMENT INTERFACE DISPLAY WITH CONTINUOUSLY CONNECTED DATA DISPLAY ELEMENTS THROUGH A SINGLE CONTINUOUS CONTACT WITH THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 217, process flow proceeds to TRANSFORM EACH DISPLAY REGION CONTACTED BY THE SINGLE CONTINUOUS CONTACT WITH THE DISPLAY SCREEN INTO A SELECTED DISPLAY ELEMENT OPERATION 219.

In one embodiment, at TRANSFORM EACH DISPLAY REGION CONTACTED BY THE SINGLE CONTINUOUS CONTACT WITH THE DISPLAY SCREEN INTO A SELECTED DISPLAY ELEMENT OPERATION 219 for each display region of DESIGNATE TWO OR MORE DISPLAY REGIONS OF THE MULTI-DISPLAY ELEMENT INTERFACE DISPLAY WITH CONTINUOUSLY CONNECTED DATA DISPLAY ELEMENTS OPERATION 209 contacted by the user's single continuous contact motion with the display screen at PROVIDE THE USER THE CAPABILITY TO MAKE CONTACT WITH TWO OR MORE OF THE DISPLAY REGIONS IN THE MULTI-DISPLAY ELEMENT INTERFACE DISPLAY WITH CONTINUOUSLY CONNECTED DATA DISPLAY ELEMENTS THROUGH A SINGLE CONTINUOUS CONTACT WITH THE MULTI-DISPLAY ELEMENT INTERFACE DISPLAY WITH CONTINUOUSLY CONNECTED DATA DISPLAY ELEMENTS ON THE DISPLAY SCREEN OF THE COMPUTING SYSTEM OPERATION 217, the display element of GENERATE THE DISPLAY ELEMENTS REPRESENTING THE DATA ELEMENTS OPERATION 205 corresponding to the contacted display region is transformed into a selected display element.

In one embodiment, once for each display region contacted by the user's single continuous contact motion with the display screen the display element corresponding to the contacted display region is transformed into a selected display element at TRANSFORM EACH DISPLAY REGION CONTACTED BY THE SINGLE CONTINUOUS CONTACT WITH THE DISPLAY SCREEN INTO A SELECTED DISPLAY ELEMENT OPERATION 219, process flow proceeds to TRANSFORM THE DATA ELEMENTS ASSOCIATED WITH EACH OF THE SELECTED DISPLAY ELEMENTS INTO SELECTED DATA ELEMENTS OPERATION 221.

In one embodiment, at TRANSFORM THE DATA ELEMENTS ASSOCIATED WITH EACH OF THE SELECTED DISPLAY ELEMENTS INTO SELECTED DATA ELEMENTS OPERATION 221 the data elements associated with each of the selected display elements of TRANSFORM EACH DISPLAY REGION CONTACTED BY THE SINGLE CONTINUOUS CONTACT WITH THE DISPLAY SCREEN INTO A SELECTED DISPLAY ELEMENT OPERATION 219 are transformed into selected data elements.

In one embodiment, once the data elements associated with each of the selected display elements are transformed into selected data elements at TRANSFORM THE DATA ELEMENTS ASSOCIATED WITH EACH OF THE SELECTED DISPLAY ELEMENTS INTO SELECTED DATA ELEMENTS OPERATION 221, process flow proceeds to ACCUMULATE THE SELECTED DATA ELEMENTS IN A SELECTED DATA ELEMENT SET OPERATION 223.

In one embodiment, at ACCUMULATE THE SELECTED DATA ELEMENTS IN A SELECTED DATA ELEMENT SET OPERATION 223 the selected data elements are accumulated in a selected data element set.

In one embodiment, once the selected data elements are accumulated in a selected data element set at ACCUMULATE THE SELECTED DATA ELEMENTS IN A SELECTED DATA ELEMENT SET OPERATION 223, process flow proceeds to STORE THE SELECTED DATA ELEMENT SET AS SELECTED DATA OPERATION 225

In one embodiment, at STORE THE SELECTED DATA ELEMENT SET AS SELECTED DATA OPERATION 225 the selected data element set of ACCUMULATE THE SELECTED DATA ELEMENTS IN A SELECTED DATA ELEMENT SET OPERATION 223 is stored as selected data.

In one embodiment, once the selected data element set is stored as selected data at STORE THE SELECTED DATA ELEMENT SET AS SELECTED DATA OPERATION 225, process flow proceeds to EXIT OPERATION 230.

In one embodiment, at EXIT OPERATION 230 process 200 for providing a multi-display element interface display with continuously connected data display elements selectable through a single continuous motion is exited to await new data.

Using process 200 for providing a multi-display element interface display with continuously connected data display elements selectable through a single continuous motion discussed herein, a solution to the long standing problem of providing an efficient method and system to select a desired subset of display elements through a multi-display element interface display is provided that significantly improves the technical fields of data entry/selection and user experience. Specifically, a user's experience is improved and simplified using process 200 for providing a multi-display element interface display with continuously connected data display elements selectable through a single continuous motion so that the user experience is less burdensome and the user can dedicate more of his or her time to other activities. Therefore, implementations of embodiments of the present disclosure represent a significant improvement to the field of user experience and, in particular, efficient use of human and non-human resources.

In addition, by eliminating the necessity of individually selecting each desired display element in a multi-display element interface display, there are fewer data entry actions to process, and fewer errors in the entered data. Consequently, using process 200 for providing a multi-display element interface display with continuously connected data display elements selectable through a single continuous motion, fewer processor cycles are utilized for data entry, and the correction of erroneous data entry, memory utilization is reduced, and less communications bandwidth is utilized to relay data to backend systems. As a result, computing systems, and particularly mobile computing systems, are transformed into faster, more efficient, and more effective computing systems by implementing process 200 for providing a multi-display element interface display with continuously connected data display elements selectable through a single continuous motion.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “accessing,” “analyzing,” “obtaining,” “identifying,” “associating,” “aggregating,” “initiating,” “collecting,” “creating,” “transferring,” “storing,” “searching,” “comparing,” “providing,” “processing” etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes by a computer program stored via a computer program product as defined herein that can be accessed by a computing system or other device to transform the computing system or other device into a specifically and specially programmed computing system or other device.

Those of skill in the art will readily recognize that the algorithms and operations presented herein are not inherently related to any particular computing system, computer architecture, computer or industry standard, or any other specific apparatus. It may prove convenient/efficient to construct or transform one or more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity, and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s are identified using a particular nomenclature for ease of description and understanding, but other nomenclature is often used in the art to identify equivalent operations.

In the discussion above, certain aspects of one embodiment include process steps and/or operations and/or instructions described herein for illustrative purposes in a particular order and/or grouping. However, the particular order and/or grouping shown and discussed herein is illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein does not limit the scope of the invention as claimed below.

Therefore, numerous variations, whether explicitly provided for by the specification or implied by the specification or not, may be implemented by one of skill in the art in view of this disclosure.

What is claimed is:

1. A computing system implemented method for providing a multi-display element interface display with continuously connected data display elements selectable through a single continuous motion comprising:
defining two or more data elements to be represented by display elements in a multi-display element interface display with continuously connected data display elements;
generating the display elements representing the data elements;
associating each data element to a corresponding display element;
designating two or more display regions of the multi-display element interface display with continuously connected data display elements, each of the display regions of the multi-display element interface display with continuously connected data display elements being physically positioned in the multi-display element interface display with continuously connected data display elements such that at least a portion of each display region is represented as connected to at least one other display region;
displaying each display element in a corresponding display region of the multi-display element interface display with continuously connected data display elements such that each display element is displayed in that display element's corresponding display region of the multi-display element interface display with continuously connected data display elements;
displaying the multi-display element interface display with continuously connected data display elements on a display screen of a computing system;
providing a user access to the multi-display element interface display with continuously connected data display elements on the display screen of the computing system;
providing the user the capability to make contact with two or more continuously connected display regions of the display regions in the multi-display element interface display with continuously connected data display elements through a single continuous contact with multi-display element interface display on the display screen of the computing system wherein;
for each display regions display region contacted by the single continuous contact with the display screen, the display element corresponding to the contacted display region is transformed into a selected display element, further wherein;
the data elements associated with each of the selected display elements are transformed into selected data elements;
the selected data elements are accumulated in a selected data element set; and
the selected data element set is stored as selected data.

2. The computing system implemented method of claim 1 wherein the display regions of the multi-display element interface display with continuously connected data display elements are arranged in one or more columns so that each display region is physically positioned in the multi-display element interface display with continuously connected data display elements such that at least a portion of each display region is represented as connected to at least one other display region.

3. The computing system implemented method of claim 2 wherein the single continuous contact with multi-display element interface display on the display screen of the computing system includes a substantially vertical swiping motion through at least part of one of the one or more columns of display regions.

4. The computing system implemented method of claim 2 wherein the single continuous contact with multi-display element interface display on the display screen of the computing system includes a substantially diagonal swiping motion through at least part of one of the one or more columns of display regions.

5. The computing system implemented method of claim 2 wherein the single continuous contact with multi-display element interface display on the display screen of the computing system includes:
a substantially vertical swiping motion through at least part of a first column of the one or more columns of display regions;
a substantially horizontal swiping motion; and
a second a substantially vertical swiping motion through at least part of a second one of the one or more columns of display regions, the second column of display regions being different from the first column of display regions.

6. The computing system implemented method of claim 1 wherein the display regions of the multi-display element interface display with continuously connected data display elements are arranged in one or more rows so that each display region is physically positioned in the multi-display element interface display with continuously connected data display elements such that at least a portion of each display region is represented as connected to at least one other display region.

7. The computing system implemented method of claim 6 wherein the single continuous contact with multi-display element interface display on the display screen of the computing system includes a substantially horizontal swiping motion through at least part of one of the one or more rows of display regions.

8. The computing system implemented method of claim 6 wherein the single continuous contact with multi-display element interface display on the display screen of the computing system includes a substantially diagonal swiping motion through at least part of one of the one or more rows of display regions.

9. The computing system implemented method of claim 6 wherein the single continuous contact with multi-display element interface display on the display screen of the computing system includes:
a substantially horizontal swiping motion through at least part of a first row of the one or more rows of display regions;
a substantially vertical swiping motion; and
a second a substantially horizontal swiping motion through at least part of a second one of the one or more rows of display regions, the second row of display regions being different from the first row of display regions.

10. The computing system implemented method of claim 1 wherein the display regions of the multi-display element interface display with continuously connected data display elements are arranged in a substantially circular arrangement so that each display region is physically positioned in the multi-display element interface display with continuously connected data display elements such that at least a portion of each display region is represented as connected to at least one other display region.

11. The computing system implemented method of claim 10 wherein the single continuous contact with multi-display element interface display on the display screen of the computing system includes a substantially curved swiping motion through at least two of the two or more display regions.

12. The computing system implemented method of claim 1 wherein the display regions of the multi-display element interface display with continuously connected data display elements are arranged in a substantially curved arrangement so that each display region is physically positioned in the multi-display element interface display with continuously connected data display elements such that at least a portion of each display region is represented as connected to at least one other display region.

13. The computing system implemented method of claim 12 wherein the single continuous contact with multi-display element interface display on the display screen of the computing system includes a substantially curved swiping motion through at least two of the two or more display regions.

14. The computing system implemented method of claim 1 further comprising:
once the user has made contact with two or more of the display regions in the multi-display element interface display with continuously connected data display elements through a single continuous contact with multi-display element interface display on the display screen of the computing system, if the user makes a second contact with the a previously contacted display region, the display element corresponding to the contacted display region is transformed into a deselected display element, further wherein;
the data elements associated with each of the deselected display elements are transformed into deselected data elements; and
the deselected data elements are removed from selected data element set.

15. A system for providing a multi-display element interface display with continuously connected data display elements selectable through a single continuous motion comprising:
data elements to be represented by display elements in a multi-display element interface display with continuously connected data display elements, each data element corresponding to its own display element;
a multi-display element interface display with continuously connected data display elements;
two or more display regions of the multi-display element interface display with continuously connected data display elements, each of the display regions of the multi-display element interface display with continuously connected data display elements being physically positioned in the multi-display element interface display with continuously connected data display elements such that at least a portion of each display region is represented as connected to at least one other display region, each display element being displayed in a corresponding display region of the multi-display element interface display with continuously connected data display elements such that each display element is displayed in that display element's corresponding display region of the multi-display element interface display with continuously connected data display elements;
a display screen of a computing system, the multi-display element interface display with continuously connected data display elements being displayed on the display screen of the computing system, the display screen of the computing system allowing a user the capability to make contact with two or more continuously connected data display regions of the display regions in the multi-display element interface display with continuously connected data display elements through a single continuous contact with multi-display element interface display on the display screen of the computing system wherein;
for each display region contacted by the single continuous contact with the display screen, the display element corresponding to the contacted display region is transformed into a selected display element, further wherein;
the data elements associated with each of the selected display elements are transformed into selected data elements;
the selected data elements are accumulated in a selected data element set; and
a data storage system for storing the selected data element set as selected data.

16. The system of claim 15 wherein the display regions of the multi-display element interface display with continuously connected data display elements are arranged in one or more columns so that each display region is physically positioned in the multi-display element interface display with continuously connected data display elements such that at least a portion of each display region is represented as connected to at least one other display region.

17. The system of claim 16 wherein the single continuous contact with multi-display element interface display on the display screen of the computing system includes a substantially vertical swiping motion through at least part of one of the one or more columns of display regions.

18. The system of claim 16 wherein the single continuous contact with multi-display element interface display on the display screen of the computing system includes a substantially diagonal swiping motion through at least part of one of the one or more columns of display regions.

19. The system of claim 16 wherein the single continuous contact with multi-display element interface display on the display screen of the computing system includes:
a substantially vertical swiping motion through at least part of a first column of the one or more columns of display regions;
a substantially horizontal swiping motion; and
a second a substantially vertical swiping motion through at least part of a second one of the one or more columns of display regions, the second column of display regions being different from the first column of display regions.

20. The system of claim 15 wherein the display regions of the multi-display element interface display with continuously connected data display elements are arranged in one or more rows so that each display region is physically positioned in the multi-display element interface display with continuously connected data display elements such that at least a portion of each display region is represented as connected to at least one other display region.

21. The system of claim 20 wherein the single continuous contact with multi-display element interface display on the display screen of the computing system includes a substantially horizontal swiping motion through at least part of one of the one or more rows of display regions.

22. The system of claim 20 wherein the single continuous contact with multi-display element interface display on the display screen of the computing system includes a substantially diagonal swiping motion through at least part of one of the one or more rows of display regions.

23. The system of claim 20 wherein the single continuous contact with multi-display element interface display on the display screen of the computing system includes:
a substantially horizontal swiping motion through at least part of a first row of the one or more rows of display regions;
a substantially vertical swiping motion; and
a second a substantially horizontal swiping motion through at least part of a second one of the one or more rows of display regions, the second row of display regions being different from the first row of display regions.

24. The system of claim 15 wherein the display regions of the multi-display element interface display with continuously connected data display elements are arranged in a substantially circular arrangement so that each display region is physically positioned in the multi-display element interface display with continuously connected data display elements such that at least a portion of each display region is represented as connected to at least one other display region.

25. The system of claim 24 wherein the single continuous contact with multi-display element interface display on the display screen of the computing system includes a substantially curved swiping motion through at least two of the two or more display regions.

26. The system of claim 15 wherein the display regions of the multi-display element interface display with continuously connected data display elements are arranged in a substantially curved arrangement so that each display region is physically positioned in the multi-display element interface display with continuously connected data display elements such that at least a portion of each display region is represented as connected to at least one other display region.

27. The system of claim 26 wherein the single continuous contact with multi-display element interface display on the display screen of the computing system includes a substantially curved swiping motion through at least two of the two or more display regions.

28. The system of claim 15 wherein once the user has made contact with two or more of the display regions in the multi-display element interface display with continuously connected data display elements through a single continuous contact with multi-display element interface display on the display screen of the computing system, if the user makes a second contact with the a previously contacted display region, the display element corresponding to the contacted display region is transformed into a deselected display element, further wherein;
the data elements associated with each of the deselected display elements are transformed into deselected data elements; and
the deselected data elements are removed from selected data element set.

29. A computer-readable medium having a plurality of computer-executable instructions which, when executed by one or more processors, perform a method for providing a multi-display element interface display with continuously connected data display elements selectable through a single continuous motion, the method for providing a multi-display element interface display with continuously connected data display elements selectable through a single continuous motion comprising:
defining two or more data elements to be represented by display elements in a multi-display element interface display with continuously connected data display elements;
generating the display elements representing the data elements;
associating each data element to a corresponding display element;
designating two or more display regions of the multi-display element interface display with continuously connected data display elements, each of the display regions of the multi-display element interface display with continuously connected data display elements being physically positioned in the multi-display element interface display with continuously connected data display elements such that at least a portion of each display region is represented as connected to at least one other display region;
displaying each display element in a corresponding display region of the multi-display element interface display with continuously connected data display elements such that each display element is displayed in that display element's corresponding display region of the multi-display element interface display with continuously connected data display elements;
displaying the multi-display element interface display with continuously connected data display elements on a display screen of a computing system;
providing a user access to the multi-display element interface display with continuously connected data display elements on the display screen of the computing system;
providing the user the capability to make contact with two or more continuously connected data display regions of the display regions in the multi-display element interface display with continuously connected data display elements through a single continuous contact with multi-display element interface display on the display screen of the computing system wherein;
for each display region contacted by the single continuous contact with the display screen, the display element corresponding to the contacted display region is transformed into a selected display element, further wherein;
the data elements associated with each of the selected display elements are transformed into selected data elements;
the selected data elements are accumulated in a selected data element set; and
the selected data element set is stored as selected data.

30. The computer-readable medium of claim 29 wherein the display regions of the multi-display element interface display with continuously connected data display elements are arranged in one or more columns so that each display region is physically positioned in the multi-display element interface display with continuously connected data display elements such that at least a portion of each display region is represented as connected to at least one other display region.

31. The computer-readable medium of claim 30 wherein the single continuous contact with multi-display element interface display on the display screen of the computing system includes a substantially vertical swiping motion through at least part of one of the one or more columns of display regions.

32. The computer-readable medium of claim 30 wherein the single continuous contact with multi-display element interface display on the display screen of the computing system includes a substantially diagonal swiping motion through at least part of one of the one or more columns of display regions.

33. The computer-readable medium of claim 30 wherein the single continuous contact with multi-display element interface display on the display screen of the computing system includes:
a substantially vertical swiping motion through at least part of a first column of the one or more columns of display regions;
a substantially horizontal swiping motion; and
a second a substantially vertical swiping motion through at least part of a second one of the one or more columns of display regions, the second column of display regions being different from the first column of display regions.

34. The computer-readable medium of claim 29 wherein the display regions of the multi-display element interface display with continuously connected data display elements are arranged in one or more rows so that each display region is physically positioned in the multi-display element interface display with continuously connected data display elements such that at least a portion of each display region is represented as connected to at least one other display region.

35. The computer-readable medium of claim 34 wherein the single continuous contact with multi-display element interface display on the display screen of the computing system includes a substantially horizontal swiping motion through at least part of one of the one or more rows of display regions.

36. The computer-readable medium of claim 34 wherein the single continuous contact with multi-display element interface display on the display screen of the computing system includes a substantially diagonal swiping motion through at least part of one of the one or more rows of display regions.

37. The computer-readable medium of claim 34 wherein the single continuous contact with multi-display element interface display on the display screen of the computing system includes:
a substantially horizontal swiping motion through at least part of a first row of the one or more rows of display regions;
a substantially vertical swiping motion; and
a second a substantially horizontal swiping motion through at least part of a second one of the one or more rows of display regions, the second row of display regions being different from the first row of display regions.

38. The computer-readable medium of claim 29 wherein the display regions of the multi-display element interface display with continuously connected data display elements are arranged in a substantially circular arrangement so that each display region is physically positioned in the multi-display element interface display with continuously connected data display elements such that at least a portion of each display region is represented as connected to at least one other display region.

39. The computer-readable medium of claim 38 wherein the single continuous contact with multi-display element interface display on the display screen of the computing system includes a substantially curved swiping motion through at least two of the two or more display regions.

40. The computer-readable medium of claim 29 wherein the display regions of the multi-display element interface display with continuously connected data display elements are arranged in a substantially curved arrangement so that each display region is physically positioned in the multi-display element interface display with continuously connected data display elements such that at least a portion of each display region is represented as connected to at least one other display region.

41. The computer-readable medium of claim 40 wherein the single continuous contact with multi-display element interface display on the display screen of the computing system includes a substantially curved swiping motion through at least two of the two or more display regions.

42. The computer-readable medium of claim 29 wherein once the user has made contact with two or more of the display regions in the multi-display element interface display with continuously connected data display elements through a single continuous contact with multi-display element interface display on the display screen of the computing system, if the user makes a second contact with the a previously contacted display region, the display element corresponding to the contacted display region is transformed into a deselected display element, further wherein;
the data elements associated with each of the deselected display elements are transformed into deselected data elements; and
the deselected data elements are removed from selected data element set.
